(19) United States
(12) Patent Application Publication
(10) Pub. No.: US 2018/0089339 A1
(43) Pub. Date: Mar. 29, 2018

(54) Photovoltaic Installation Design Systems

(71) Applicant: Aurora Solar Inc., Palo Alto, CA (US)

(72) Inventors: Madeleine Richards Udell, Ithaca, NY (US); Patrick Oliver Toole, Palo Alto, CA (US)

(21) Appl. No.: 15/717,913

(22) Filed: Sep. 27, 2017

Related U.S. Application Data
(60) Provisional application No. 62/400,542, filed on Sep. 27, 2016.

(51) Int. Cl. G06F 17/50; H02S 20/23

(52) U.S. Cl. CPC G06F 17/5004; G06F 2217/78; G06F 2217/04; H02S 20/23

(57) ABSTRACT

A PV design system determines installation plans for installing PV panels on roofs according to design objectives. The PV design system determines installation plans by optimizing associated costs and output energy production while satisfying constraints. In one implementation, the PV design system determines a number of PV panels and a number of PV optimization modules that can be used together to output at least a desired energy output. The PV design system further determines positioning of the PV panels on roof faces of the roof, groupings of the PV panels, assignment of the PV panels to PV strings, and connection of the PV strings to the PV optimization modules.

### CROSS-REFERENCE TO RELATED APPLICATION(S)

This application claims priority under 35 U.S.C. § 119(e) to U.S. Provisional Patent Application Ser. No. 62/400,542, “Optimal Design of Residential Photovoltaic Arrays,” filed Sep. 27, 2016. The subject matter of all of the foregoing is incorporated herein by reference in their entirety.

### BACKGROUND

Renewable energy is clean and sustainable. Solar energy is one dominant source for renewable energy production. Distributed generation of solar power has gained popularity. Photovoltaics (PV) panels that convert sunlight into electric power are installed on residential rooftops. However, it is challenging to design installation of PV panels that meets users' objectives.

### SUMMARY

Described herein are processes and systems that determine PV installation plans for installing PV panels on roofs according to design objectives. A PV installation plan includes a number of PV panels positioned on one or more roof faces, assignment of the PV panels to PV strings, and connection of the PV strings to a number of PV optimization modules. The PV installation plans are determined to optimize a total cost of the devices and an energy production while satisfying constraints. Compared to designs produced by human experts, processes and systems as presented herein determine more cost-efficient PV installation plans that consistently comply with physical and legal requirements that are often disregarded or violated by human experts.

### BRIEF DESCRIPTION OF THE DRAWINGS

FIG. 1A illustrates a computing environment for determining photovoltaic (PV) panel installation plans, according to one embodiment.

FIG. 1B illustrates an example site for PV installation.

FIG. 2 illustrates an example I-V curve for an example PV panel.

FIG. 3 illustrates an example process of designing PV installation, according to one embodiment.

FIG. 4 illustrates presenting an example installation plan for an example roof.

FIG. 5 is a high-level block diagram illustrating an example computer.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

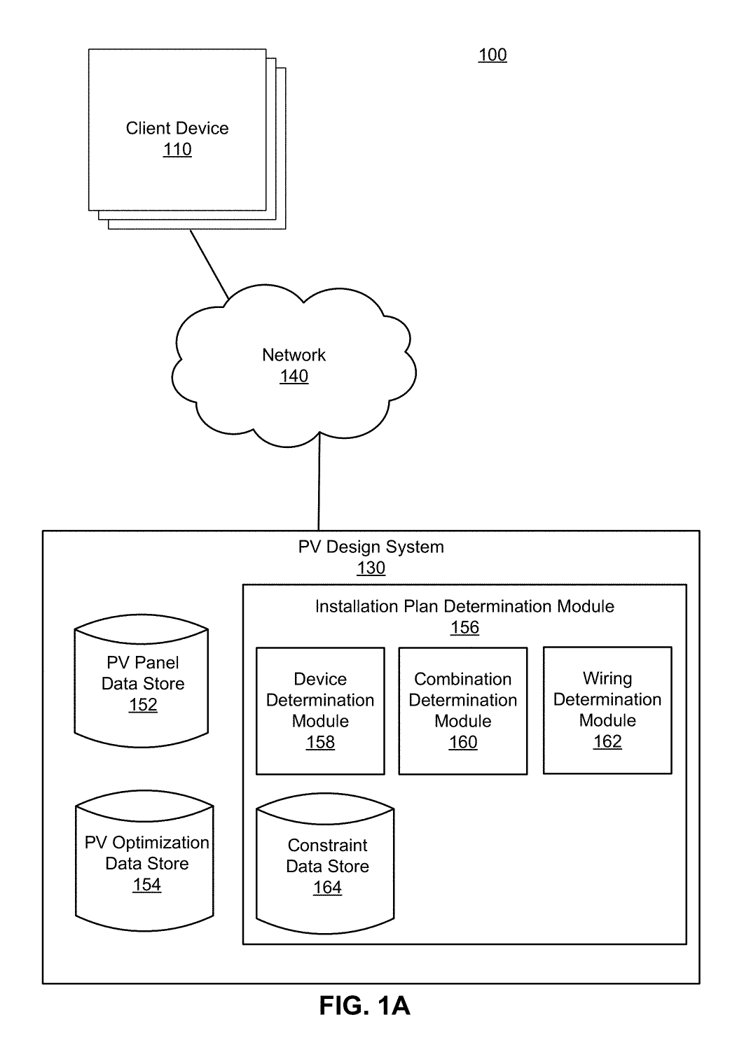

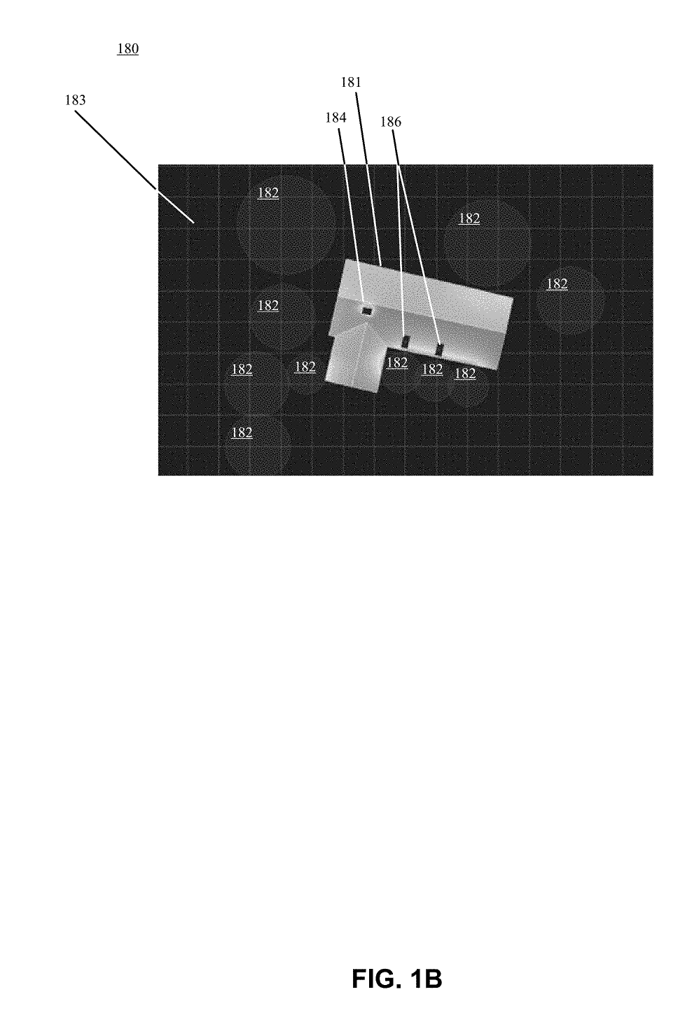

FIG. 1A illustrates a computing environment 100 for determining photovoltaic (PV) panel installation plans, according to one embodiment. The environment includes entities such as client device 110, a PV design system 130, and a network 140. The network 140 connects the client devices 110 and the PV design system 130. In the illustrated example, only one PV design system 130 is shown, but there may be multiple instances of the PV design system 130. A “PV panel installation plan” is also hereinafter referred to as an “installation plan.”

Client devices 110 include computing devices such as mobile devices (e.g., smartphones or tablets with operating systems such as Android or Apple IOS), laptop computers, desktop computers, or any other type of network-enabled device that enable users to receive PV panel installation design services from the PV design system 130. A client device 110 may query an API hosted by the PV design system 130. A client device 110 may also determine PV panel installation designs by executing a PV design program installed thereon, for example, in its read only memory (ROM). A client device 110 typically includes hardware and software to connect to the network 140 (e.g., via Wi-Fi and/or Long Term Evolution (LTE) or other wireless telecommunication standards), and to receive input from the users. In addition to enabling a user to receive a user PV panel installation design services from the PV design system 130, the client devices 110 may also provide the PV design system 130 with PV design information. Example PV design information includes roof data (e.g., a representation of a roof, a picture or image of a roof, a picture or image of a neighboring area surrounding the roof, shading data, or irradiance data), ground irradiance data, weather data, or PV design parameters such as a desired energy output, a desired type of PV panel, a budget, and the like.

The network 140 is the communication pathway between the client devices 110 and the PV design system 130. In one embodiment, the network 140 uses standard communications technologies and/or protocols and can include the Internet. Thus, the network 140 can include links using technologies such as Ethernet, 802.11, InfiniBand, PCI Express Advanced Switching, etc. Similarly, the networking protocols used on the network 140 can include multiprotocol label switching (MPLS), transmission control protocol/Internet protocol (TCP/IP), User Datagram Protocol (UDP), hypertext transport protocol (HTTP) and secure hypertext transport protocol (HTTPS), simple mail transfer protocol (SMTP), file transfer protocol (FTP), etc. The data exchanged over the network 140 can be represented using technologies and/or formats including image data in binary form (e.g., Portable Network Graphics (PNG)), hypertext markup language (HTML), extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In another embodiment, the entities on the network 140 can use custom and/or dedicated data communications technologies instead of, or in addition to, the ones described above.

The PV design system 130 determines one or more installation plans for installing PV panels on a roof. The PV panels form one or more PV arrays. A PV array includes an array of PV panels that are be connected in parallel or in series. A series of PV panels that are connected in series are hereinafter referred to as “a PV string.” A quantity of PV panels included in a PV string is referred herein as “a string length.” The PV array may additionally include one or more of power optimization modules (e.g., a string inverter, a microinverter, a power optimizer), batteries, bypass diodes, and the like. Consider the example site 180 shown in FIG. 1B. The example site 180 includes a roof 181 and a surrounding area 183. On the roof 181, different shades of gray reflect different amounts of average annual insolation on different regions of the roof 181. As illustrated, darker gray areas receive more insolation and lighter gray areas receive less insolation. The rectangle outlined by a circle 184 represents a chimney, skylight, or other roof obstructions. The rectangles 186 represents solar panels. In the surrounding area 183, the circles 182 represent locations of trees. When creating a PV installation strategy for this site 180 to generate at least 11 kWh every year, the PV panels are preferably placed in areas with more insolation.

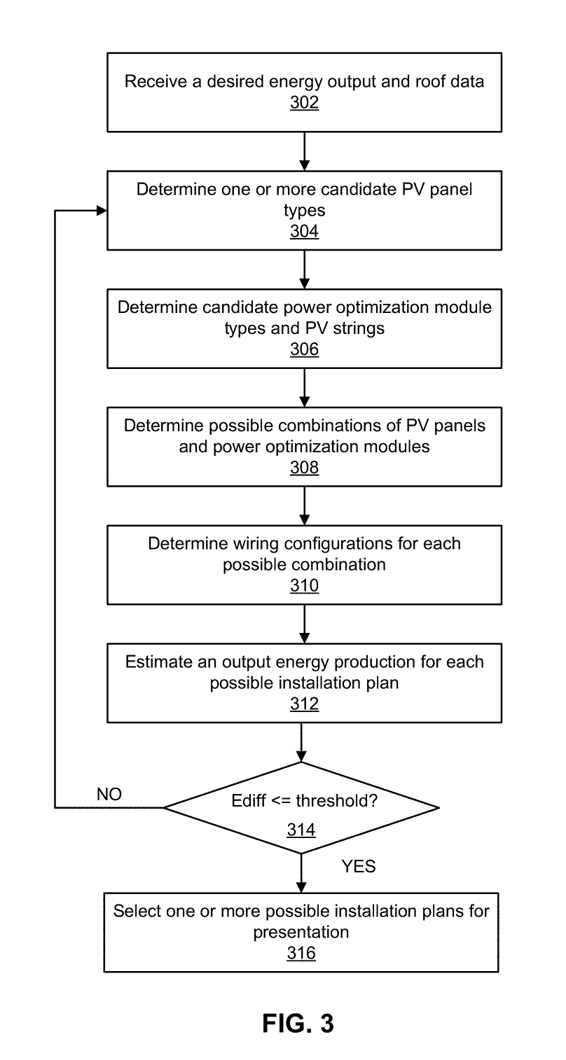

The PV design system 130 designs PV installation plans for roofs according to PV design objectives. A design objective includes one or more design parameters such as a desired energy output, a budget, a preferred PV panel, a preferred roof face for installing PV panels, and the like. The design objective is provided by a user. The PV design system 130 receives roof data including information about the roof for which PV installation is designed. The roof data includes a representation of the roof and other information about the roof as further described with reference to FIG. 3. The PV design system 130 includes an installation plan determination module 156, a PV panel data store 152, and a PV optimization data store 154, all of which are further described below.

The PV panel data store 152 stores PV panel data associated with PV panels of different PV panel types. A particular type of PV panel is identified by its unique ID. The PV panel data associated with a particular type of PV panel includes a capacity, an output power range, an output voltage range, an output current range, a weight, a dimension, an I-V (current-voltage) curve, a cost, and the like.

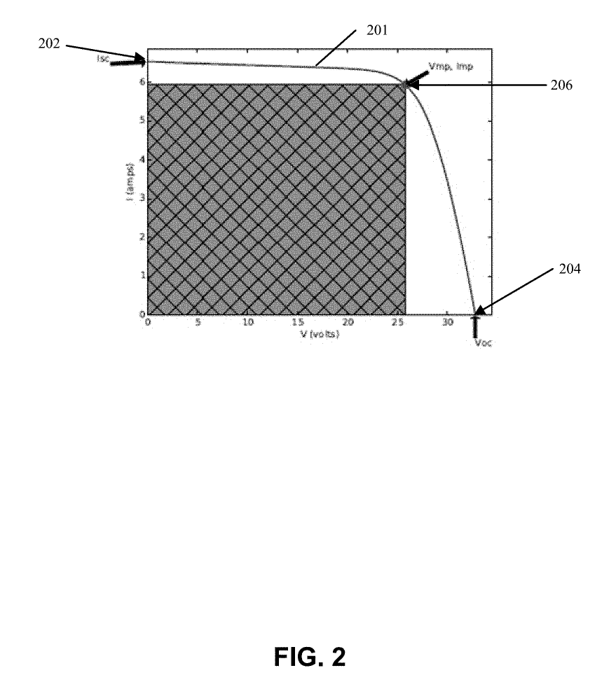

A PV panel outputs electrical currents and voltages. For a given PV panel, its output power is determined by its operating condition that is determined by an amount of irradiance incident on the PV panel, a temperature, and a load. An amount of irradiance incident on the PV panel can be determined based on an orientation of a PV panel relative to sunlight incident on the PV panel. For a given amount of sunlight, a PV panel outputs its maximum power if it is positioned such that its surface is perpendicular to a direction of the sunlight. An I-V (current-voltage) curve of a PV panel defines a relationship between its output voltage and output current under a given operating condition. FIG. 2 illustrates an example I-V curve 201 for an example PV panel. On the curve 201, the point 202 corresponds to the short circuit current Isc (i.e., the output current through the PV panel when the output voltage is zero). The point 204 corresponds to the open circuit voltage Voc (i.e., the output voltage across the panel when the output current is zero). The point 204 corresponds to the maximum output power. For any PV panel, its short circuit current Isc increases with an increase in the amount of irradiance on the PV panel, and its open circuit voltage Voc decreases with an increase in the temperature.

The PV optimization module data store 154 stores PV optimization module data associated with PV optimization modules of different PV optimization types. A particular type of PV optimization module is identified by its unique ID. The PV optimization module data associated with a particular type of PV optimization module includes a capacity, an input power range, an input voltage range, an input current range, a weight, a dimension, an efficiency, a cost, a number or a range of PV panels (e.g., a PV panel of a particular type) that can be connected, a minimum number of PV panels that can be connected, a number of PV strings that can be connected, a string length of a PV string that can be connected, a number of maximum power point tracking (MPPT) modules included, an operating temperature range, and the like.

A power optimization module maximizes a PV panel's output power under a particular operating condition, for example, by adjusting the PV panel's output current or output voltage. A power optimization module can additionally convert DC (direct current) power outputted by the PV panel to AC (alternating current) power. An input of the power optimization module is coupled to an output of a PV panel. An output of the power optimization module can be coupled to a power inverter, a local electric power network (e.g., a household), or to an interconnected electric power grid. A power optimization module can be a microinverter, a string inverter, or a power optimizer.

A microinverter and a power optimizer optimize a single PV panel's operation. In contrast, a string inverter can optimize multiple PV panels' operation. A microinverter includes a maximum power point tracking (MPPT) module that maximizes an output power of the connected PV panel under a given condition by adjusting an output current of the PV panel. A string inverter includes one or more MPPT modules such that it can adjust one or more connected PV panels' output current. A power optimizer does not invert DC power into AC power whereas a microinverter and a string inverter can. A power optimizer is a DC-to-DC converter that maximizes an output of a PV panel by adjusting the connected PV panel's output voltage. Different types of power optimization modules have different costs, capabilities, and efficiency. For example, to regulate the operation of a single PV array, one string inverter is sufficient whereas multiple microinverters or power optimizers may be needed. However, microinverters or power optimizers have a higher efficiency and thus is more energy efficient than a string inverter. Furthermore, to regulate the same amount of power, it typically costs more to use microinverters than string inverters.

The installation plan determination module 156 determines one or more installation plans for installing PV panels on a particular roof according to a PV design objective. A PV installation plan includes a number of PV panels positioned on one or more roof faces, assignment of the PV panels to PV strings, and connection of the PV strings to a number of PV optimization modules. The PV installation plans are determined to optimize a total cost of the devices and an energy production while satisfying constraints. The PV design system 130 may determine candidate PV panel types and candidate PV optimization module types for determination of PV installation plans.

In some embodiments, the installation plan determination module 156 determines a possible combination of PV panels and PV optimization modules as well as wirings thereof, for example, by using a mixed integer linear programming (MILP) formulation. The installation plan determination module 156 refines the determined placement and wiring, for example, by using a bisection refinement routine. Subsequently, the installation plan determination module 156 polishes the results of the linear approximation, for example, by using a local search routine. Additionally, the installation plan may determine the sizing and routing of wires and other balance of system (BOS) components. The installation plan determination module 156 includes a device determination module 158, a combination determination module 160, a wiring determination module 162, and a constraint data store 164, all of which are further described below.

The device determination module 158 determines one or more device types (e.g., a PV panel type, a PV optimization panel type) that can be used as candidates for determining installation plans to meet the PV design objective. For a device type, the device determination module 158 can determine a number of devices that are needed to meet the design objective. The device determination module 158 selects one or more candidate PV panel types from the different types of PV panels that are stored in the PV panel data store 152 based on the PV design objective as well as PV panel data associated with the PV panels. For a candidate PV panel type, the device determination module 158 can further determine candidate locations on a roof face for positioning PV panels of the type. The device determination module 158 selects one or more candidate PV optimization module types from the different types of PV optimization modules that are stored in the PV optimization data store 154 based on the PV design objective, PV optimization data associated with the PV optimization modules, and the determined PV panel types. The device determination module 158 may further determine one or more candidate PV strings based at least on the candidate PV optimization module types. Details of the determination are further described in connection with FIG. 3.

The combination determination module 160 determines one or more possible combinations of devices that can meet or optimize the design objective. A possible combination of devices include a combination of PV panels and power optimization modules. The PV panel types of the PV panels are selected from the candidate PV panel types. The PV optimization types of the PV optimization modules are selected from the candidate PV optimization module types. Locations of the PV panels are selected from the candidate locations. The determination is subject to one or more constraints. That is, the one or more possible combinations are determined such that one or more constraints are satisfied. The constraints are stored in the constraint data store 204. For example, the combination determination module 160 determines the one or more possible combinations by minimizing the cost of the combined devices while meeting the design objective. Details of the determination of possible combinations are further described in connection with FIG. 3.

The wiring determination module 162 determines possible wiring configurations for each possible device combination. The wiring determination module 162 determines the wiring configurations to minimize a total length of wire segments connecting the devices. Details of the determination of possible wiring configurations are further described with in connection with FIG. 3.

The constraint data store 164 stores constraints for consideration when determining PV installation plans. Some constraints must be satisfied when determining PV installation plans. Some constraints are preferably satisfied when determining PV installation plans. The constraints include restrictions on positioning of PV panels or wiring between devices. For example, PV panels generally should not overlap, and are usually placed together in regular arrays. PV Panels may only be placed in certain areas of roofs to obey fire codes and other zoning constraints. PV panels may be prevented from being placed too close to a roof edge or to an obstruction such as a chimney. In some embodiments, PV panels are restricted to be placed parallel to the roof face. Panels can also be placed with compound tilt with reference to the roof face. The constraints may also include restrictions imposed by design objectives energy output, cost restrictions, or device' safe operating conditions.

In various embodiments, the PV design system 130 employs a mixed integer linear program (MILP) that can be solved by any standard solver such as Gurobi Optimization. In various embodiments, the PV panels are of the same type. Panels that are shaded are generally segregated from panels that are not shaded, which makes any linear approximation exact at the solution for many times. In various embodiments described herein, optimization is performed to minimize costs. Other forms of optimization such as maximizing energy while controlling cost may also be used. The maximum energy problem can be solved by using a logarithmic (in the inverse error tolerance) number of calls to a black-box solver for the minimum cost problem.

In further embodiments, the PV design system 130 optimizes financial metrics such as a return on investment (ROI), a net present value (NPV), a payback period, and a levelized cost of electricity (LCOE). The PV design system 130 receives additional input such as the cost of electricity (e.g., through a utility rate that defines the time of use (TOU) prices and tiered rate structures).

### PV Design Process

FIG. 3 illustrates an example process of designing PV installation, according to one embodiment. The PV design system 130 receives 302 a desired energy output E^{des} and roof data including information about a roof for which the PV installation plan is being determined. The desired energy is a minimum amount of energy that is expected to be generated by the PV panels installed on a roof within a predetermined time interval (e.g., a day, a month, or a year). In some embodiments, the PV design system 130 receives a desired energy output range. The roof data includes a representation of the roof. A roof includes one or more roof faces. A roof face is characterized by its unique orientation and a tilt, which can be defined by a tilt direction (i.e., the direction of steepest ascent/descent) and a pitch (the rate of ascent/descent along the tilt direction). The roof representation can be a model, a picture, or dimensional data of the roof. The roof data may further include a weight limit, an area limit where PV panels can be installed, one or more of shading data (e.g., an area of shading on a roof face, an amount of shading on a roof face, a time interval of shading on a roof face,) or irradiance data (e.g., an average amount of irradiance incident on a roof face within a time interval). The PV design system 130 may further receive data including information about a neighboring area surrounding the roof (e.g., a picture or image of a neighboring area surrounding the roof, dimensional data of the neighboring area surrounding the roof), ground irradiance information in the area surrounding the roof (e.g., an average amount of irradiance incident on the ground within a time interval), and weather information (e.g., a number of sunny days in a given month, a number of cloudy days in a given month). The PV design system 130 may further receive other PV design parameters such as a preferred PV panel type, a preferred PV optimization module type, a preferred roof face for positioning PV panels, a budget, and the like. The PV design system 130 may further receive data such as a utility rate, a net surplus compensation, a utility rate escalation, a project life, and a discount rate. The PV design parameters together define a PV design objective.

In some embodiments, the PV design system 130 may determine irradiance levels on the roof based at least on the received roof representation and weather data. The determination may be additionally based on the neighboring area surrounding the roof.

Subsequently, the PV design system 130 determines one or more possible installation plans. The PV design system 130 determines candidate PV panel types, candidate power optimization types, and/or candidate PV strings for determining possible installation plans. The PV design system 130 determines possible installation plans that having a minimum cost for PV panels of a candidate type, power optimization modules of a candidate type, and candidate PV strings. A possible installation plan includes PV panels and power optimization modules with an assignment of PV panels to PV strings as well as an assignment of PV strings to roof faces. A possible installation plan also includes locations for the PV panels. The PV design system 130 determines a possible installation plan such that the PV panels can be wired safely to the power optimization modules. Additionally, a total amount of energy produced by the PV strings or a linear approximation to the total amount of energy produced by the PV strings exceed a desired energy output.

The PV design system 130 determines 304 one or more candidate PV panel types that can be used as candidates for determining installation plans to meet the PV design objective. The one or more candidate types of PV panels may have different capacities. In some embodiments, the PV design system receives the one or more candidate types of PV panels, for example, from a user or from another process. In some embodiments, the PV system 130 determines the one or more candidate types of PV panels for installation. For example, the PV system 130 selects one or more types of PV panels that can output the desired output energy from the different types of PV panels that are stored in the PV panel data store 152. The selection can be based on one or more of PV panel data, roof data, and PV design parameters. The selection may also be based on the roof data (e.g., irradiance data, shading data) and weather information. For example, a candidate PV panel type is selected such that a number of PV panels of the candidate PV panel type together can output at least the desired output energy such that a total cost is within a budget, a total dimension is within an area limit of a roof face, and/or or a total weight is within a weight limit of a roof face.

For each candidate PV panel type, the PV design system 130 may determine candidate locations for positioning PV panels on a roof face. The PV design system 130 partitions a representation of a roof face to determine candidate locations. For example, the PV design system 130 may partition a representation of a roof face to fit as many PV panels as possible on a roof face or to fit as few PV panels in a shaded area on the roof face as possible. Each partition corresponds to a candidate location for positioning a PV panel.

For a particular candidate PV panel type, the PV design system 130 determines 306 candidate power optimization module types and candidate PV strings. The determination is based at least on the desired output energy, a capacity of a power optimization module of a particular type, and a minimum number of PV panels to be connected to the power optimization module. For a candidate PV panel type, the PV design system 130 determines candidate optimization modules (of one or more types) that can be used in conjunction with PV panels of the candidate PV panel type to meet the design objective. In various embodiments, only PV panels of the same type are used in an installation plan. The candidate optimization modules can be of the same or different candidate optimization module types. The PV design system 130 determines a set of candidate power optimization modules such that the total capacity is at least the desired energy output E^{des} and a total cost is minimal. The PV panels can be connected to different candidate power optimization modules. The determination of candidate power optimization modules and candidate PV strings can be characterized as optimizing a total cost of the power optimization modules determined according to Equation (1). The optimization is determined subject to the constraint of a total capacity of the power optimization modules determined according to Equation (2):

Σ_{iεI}cᵢnᵢ (1),

nₚ≦Σ_{iεI}nᵢmᵢ (2),

where i represents a power optimization module of a particular type, I represents the determined power optimization module types, nᵢ represents a quantity of power optimization modules of the particular type, cᵢ represents a cost of a power optimization module of a particular type, mᵢ represents the minimum number of PV panels to be connected to a power optimization module of a particular type, nₚ represents the minimum number of PV panels needed to output the desired energy E^{des}.

The PV design system 130 determines the candidate PV strings based on the candidate power optimization module types. That is, the PV design system determines possible groupings of PV panels for forming PV strings. A group of PV panel includes multiple PV panels. For each power optimization module type, the PV design system 130 identifies a string length or a string length range that can be connected to a power optimization module of that type. The PV design system 130 determines the candidate PV strings based on the string length or the string length range determined for the candidate power optimization module types.

The PV design system 130 determines a possible installation plan using the determined candidate PV panel types, candidate power optimization module types, and candidate PV strings. In some embodiments, the PV design system 130 provides the determined candidate PV panel types, candidate power optimization module types, and candidate PV strings as inputs to a mixed integer linear program (MILP) for determining the possible combinations of PV panels and power optimization modules and wiring configurations.

The PV design system 130 determines 308 one or more possible combinations of PV panels and power optimization modules. In particular, the PV design system 130 determines a quantity of PV panels, locations of the PV panels, a quantity of power optimization modules, a quantity of PV strings, an assignment of PV panels to PV strings. The determination is based at least on the desired output energy, a capacity of a PV panel, a capacity of a power optimization module, a minimum number and a maximum number of PV panels to be connected to the power optimization module, a string length or a string length range to be connected to the power optimization module, a number of roof faces, roof data associated with the roof faces, and irradiance on the roof faces. In various embodiments, for each possible installation plan, the PV panels are of the same PV panel type. The PV design system 130 determines 308 the one or more possible combinations by minimizing the cost of the combined devices while meeting the desired energy E^{des}. The determination of the possible installation plans can be characterized as optimizing a total cost of PV panels and power optimization modules according to Equation (3). The optimization is determined subject to constraints defined in Equations (4) through (9). As further described below, the Equations (4) through (9) define an output energy constraint, a power optimization module constraint, and a capacity constraint.

Σ_{jεJ}cⱼzⱼ+Σ_{pεP}cₚzₚ (3),

where j represents a power optimization module of a candidate power optimization type, cⱼ is a cost of the power optimization module, J represents the candidate power optimization modules, zⱼ is an integer having a value of 1 and 0 indicating whether or not the power optimization module is used, p represents a PV panel of a candidate PV panel type at a candidate location, P represents the candidate PV panels, cₚ is a cost of the PV panel, zₚ is an integer having a value of 1 and 0 indicating whether or not the PV panel is used.

The PV design system 130 determines the possible combinations of PV panels and power optimization modules such that a total amount of energy produced by the multiple strings is at least the desired energy E^{des}, according to Equation (4):

E^{des}≦Σ_{sεS}_{_{tεT}}eₛₜ (4),

where s represents a particular PV string, S represents a set of PV strings, T represents a time interval, t is a time point in a time interval T, eₛₜ denotes an output energy produced by a PV string s at a time point t. In some embodiments, the PV design system 130 linearizes the energy constraint according to Equation (4) as linear constraints according to Equations (5)-(6). The output energy produced by a PV string s eₛₜ is the lower bound of the energy produced by the PV string s at a time point t as shown in Equations (5)-(6), which apply to all candidate PV strings S and different time intervals T. This is because the current through a PV string is limited by the current that can be generated by the PV panel included in the PV string that receives the least amount of irradiance.

eₛₜ≦Σ_{pεP}(eₚₜNₛ+M(1−zₛₚ)) (5),

eₛₜ≦Mzₛ (6)

where eₚₜ denotes the energy output by a PV panel of a candidate PV panel type at a candidate location at a given time t, Nₛ denotes a number of PV panels included in a PV string, M is a constant, zₛₚ is an integer having a value of 1 and 0 indicating whether or not the particular PV panel is assigned to a particular PV string, zₛ is an integer having a value of 1 and 0 indicating whether or not the particular PV string is used. The PV design system 130 can configured the constant M to restrict an amount of energy that can flow through a particular PV string if a particular PV panel is assigned to the PV string, without restricting it when the particular PV panel is not assigned to the particular PV string. The PV design system 130 configures M with a lower value to reduce the numerical complexity associated with large numbers. In one embodiment, M is at least the largest output energy that can be generated by a PV string. In one embodiment, M has a value that represents infinity.

The PV design system 130 applies this linear approximation because energy output for PV panels on a given roof face are typically one of two values: a high value αₜ (under an unshaded condition) and a low value βₜ (under a shaded condition.) Accordingly, the output energy produced by individual PV panels on a particular roof face can be linearized according to Equation (7):

eₚₜ≈αₜ(1−wₚₜ)+βₜwₚₜ (7),

where wₚₜ is an integer having a value of 0 or 1 indicating a particular PV panel being shaded or unshaded at a time point t, αₜ is the average energy outputted by a panel when it is unshaded during a time interval, βₜ is the average energy outputted by a panel when it is shaded during a time interval. If an amount of irradiance incident at a given location is greater than (less than or equal to) an irradiance threshold, the PV design system 130 determines that the given location is unshaded (shaded). As described above, the PV design system 130 can calculate an amount of irradiance at a given location using roof data and weather data. Representing the energy output of a particular panel according to Equation (7) allows an integer linear program (ILP) solver to substantially eliminate or to significantly reduce the numerical complexity in selecting between candidate PV panels that have similar energy output, which leads to a faster convergence rate. In some embodiments, the PV design system employs time-series clustering to find time intervals during which a particular PV panel is shaded or unshaded. The PV design system further clusters PV panels into groups based on their output energy. As such, PV panels subject to similar amount of shading are grouped together and are separated from other PV panels subject to no shading. Details of the time-series clustering are provided below.

In some embodiments, the energy constraint is observed by a total amount of energy produced by the PV panels. The total amount of energy produced by the PV panels are at least the desired energy E^{des}. This is observed by Equation (8):

Σ_{pεP}eₚ≧E^{des} (8),

where p is an integer representing a particular PV panel, eₚ denotes an output energy produced by a PV panel p during a time interval. Compared to the Equations (4) through (6), Equation (8) has fewer variables. By considering fewer constraints, the computation complexity is reduced and it takes less time to determine the possible device combinations.

In some embodiments, the PV design system additionally assigns a particular PV string to a particular roof face. The PV design system maximizes a total amount of energy produced by the multiple strings as defined in Equation (4) subject to constraints such as the energy constraint observed in Equation (5). The PV design system additionally considers constraints such as a number of PV panels included in a PV string and a PV panel is included in one and only one PV string.

A power optimization module has a safe operating range of currents I, voltages V and powers P as shown in Equation (9).

(Nₛ,max Nsp,Nₚ)εCᵢ (9),

where i represents a particular type of power optimization module, Cᵢ denotes an operating range of a power optimization module that is specified by the manufacturers, Ns denotes a quantity of PV strings connected to the power optimization module, max Nsp denotes a maximum string length of the PV strings connected to the power optimization module, Nₚ denotes a quantity of PV panels connected to the power optimization module. The operating range of a power optimization module includes a current range, a voltage range, and a power range. The number of PV strings connected to a power optimization module is limited by the operating current range of the power optimization module. The maximum of PV panels included in a PV string that is connected to a power optimization module is limited by the operating voltage range of the power optimization module. The number of PV panels that can be connected to a power optimization module is limited by the operating power range of the power optimization module.

Furthermore, in some embodiments, the PV design system considers the following constraints when determining the possible installation plans. Every PV string is positioned on one roof face. Every PV string is connected to a power optimization module. A total number of PV strings assigned to a given power optimization module is less than a maximum total number of PV strings that can be connected to the power optimization modules. Every PV panel is included in one and only one PV string if the PV panel is selected. A PV string includes the assigned number of PV panels. In some embodiments, the PV system considers the following constraints when determining the possible installation plans. Every PV panel is positioned on one roof face. Every PV string is positioned on one roof face, and every PV string is connected to a power optimization module. By considering fewer constraints, the computation complexity is reduced and it takes less time to determine the possible device combinations. The constraints are represented as an affine inequality constraints.

The PV design system determines 410 possible wiring configurations for a possible device combination. The PV design system may determine possible wiring configurations for each possible device combination. In some embodiments, the PV design system organizes PV panels within PV strings to minimize the installation time and costs. PV panels that are separated by shorter distance are less costly and take less time to install. For a particular PV string, the PV design system identifies a wiring configuration that has the least distance connecting all PV panels of the PV string in a single tour as the possible wiring configuration. The PV design system may define a graph in which each PV panel corresponds to a node in the graph. To transform the solution into a PV string with distinct start and end points, the PV design system may remove the longest edge connecting two nodes or the edge between two PV panels that is closest to the PV optimization module to which the PV string is connected.

The PV design system estimates 412 an output energy produced by a PV design system for each possible installation plan.

The PV design system determines 414 whether a difference between the estimated output energy and the desired energy output E^{des} is less than a threshold difference. If the difference is greater than the threshold difference, the PV design system refines the possible installation plans. The PV design system refines the possible installation plans, for example, by adjusting a possible combination of PV panels and PV optimization modules or adjusting a wiring configuration connecting the PV panels and PV optimization modules. The adjustment can be performed similar to the determination of possible combinations of PV panels and PV optimization modules as well as wiring configuration as described previously. If the difference is less than the threshold difference, the PV design system selects 316 one or more installation plan for presentation to a user. In some embodiments, the PV design system selects all possible installation plans of which the difference is within the threshold difference. In some embodiments, the PV design system ranks the possible installation plans, for example, based on a number of devices, costs, or the difference between the estimated output energy and the desired energy output E^{des}. The PV design system selects one or more highest-ranked installation plans. The PV design system provides the selected possible installation plans for presentation to a user. The selected installation plans can be presented in a ranked order.

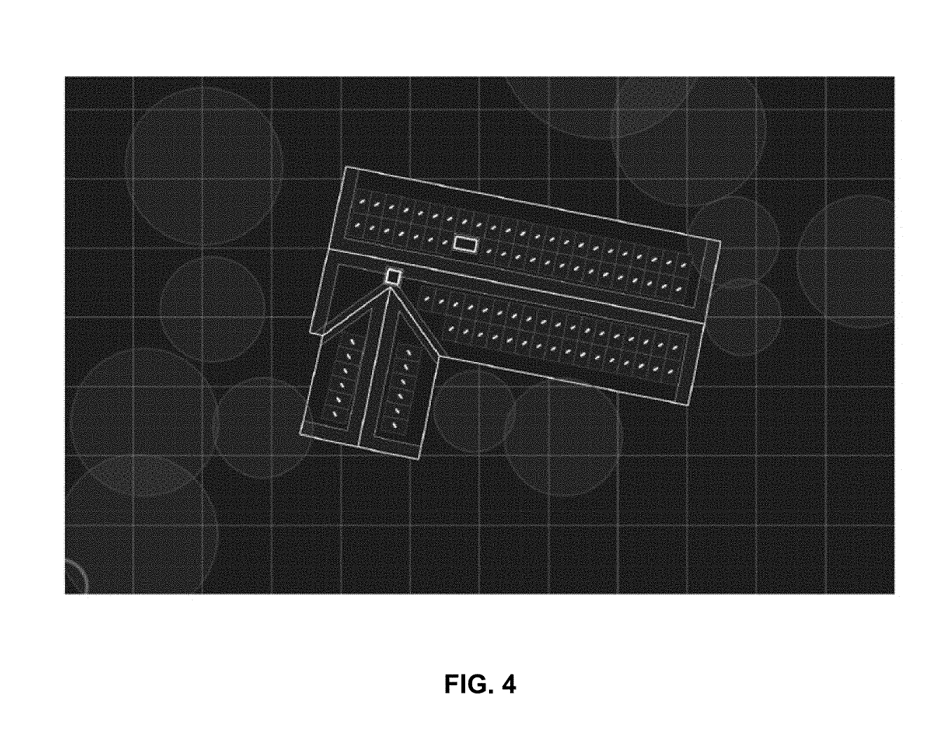

The PV design system 130 presents a selected installation plan. The PV design system 130 generates a representation of the installation plan. Representations of the PV panels and PV optimization modules are positioned relative to each other and connected according to the installation plan. The PV design system 130 generates representations of PV panels and PV optimization modules based on the PV panel data associated with the PV panels and PV optimization module data associated with the PV optimization modules. In some embodiments, the installation plan is presented by overlaying representations of PV panels and PV optimization modules as well as connections thereof on a representation of the roof such that a user can view the positioning of PV arrays and PV optimization modules on the roof. FIG. 4 illustrates presenting an example installation plan for an example roof. As illustrated, on a particular roof face, PV panels are tiled to form PV arrays.

In some embodiments, the PV design system employs a bisection method to determine an installation plan. The PV design system adjusts an upper limit and a lower limit of the estimate energy output and reiteratively determines installation plans until the upper limit and the lower limit converge to the desired energy output. The convergence can be determined by determining if a difference between the upper limit and the lower limit is within a convergence threshold. The upper limit has an initial value of the desired energy output and the lower limit has an initial value of zero. The PV design system adjusts the upper limit (or the lower limit) to the desired energy output if the estimate output energy is at least (or less than) the desired energy output. In one embodiment, the PV design system determines that the upper limit and the lower limit have converged to the desired energy output if a difference between an average of the upper limit and the lower limit and the desired energy output is within the convergence threshold.

In further embodiments, the PV design system determines whether any PV panel is an island PV panel. An island PV panel is a PV panel that is positioned separately from the other PV panels. Island PV panels increase the cost of installation, because a separate rack (beams attached to the roof) must be installed for each islanded panel. They also reduce the visual symmetry of the PV array and may be considered an eyesore.

For a given possible wiring configuration, the PV design system searches for island PV panels and repositioning island PV panels to available locations with the most adjacent panels such that the total output energy is still above the desired energy. For example, for an identified island PV panel, the PV design system can identify multiple PV panels around the island PV panel and moves the identified island PV panel to possible locations near the multiple PV panels iteratively. At each possible location, the PV design system evaluates a trade off between including the identified island module at the possible location and an amount of change in the overall energy output. The PV design system selects the location corresponds to the highest increase in energy production or lowest reduction in energy production.

### Time-Series Clustering

A time interval T is divided into time partitions T₁, . . . , Tₖ such that a particular PV panel generates the same amount of energy at each time point of a time partition Tᵢ. Therefore, the amount of energy produced by a string will be the same for every time point of a time partition. Accordingly, this allows for a reduction in the number of time intervals to be considered according to equation (7), by limiting the number of variables and constraints. Finding an optimal number of clusters k can reduce computation complexity while maintaining the accuracy because shading patterns are periodic with only slight variations daily. This can be done in a variety of ways as described below.

In some embodiments, to divide a time interval into time interval partitions, the PV design system first determines the number of time clusters k. The number k can be chosen such that the local optimization can be solved efficiently. Subsequently, the PV design system maximizes the Equation (10) by adjusting the number k thereby to find clusters during which a particular PV panel outputs the same or substantially the same energy at different time points. The number k can be adjusted by adjusting the time points tᵢ that divide the time interval partitions Ti.

Σᵢ₌₁^{k}Σ_{tεT}_{ᵢ}∥eₜ−eₜ_{ᵢ}∥ (10),

where i is a time point, Tᵢ is a time interval partition, and tᵢ is a time point.

In some embodiments, to divide a time interval into time interval partitions, instead of clustering by energy produced at each time point, the PV design system clusters by the average energy produced during a time interval. The PV design system maximizes Equation (11), which approximates an energy vectors eₜ in a cluster by the cluster centroid bᵢ.

maximize Σᵢ₌₁^{k}Σ_{tεT}_{ᵢ}∥eₜ−bᵢ∥, (11),

where i is a time point, Tᵢ is a time interval partition, and tᵢ is a time point. This problem is a standard k-means clustering problem. Note that the cluster centroid vector of energies bᵢ may possibly not be (exactly) achieved at a time.

In some embodiments, the PV design system clusters energy produced at each time point by using boolean vectors wₜε{0, 1}^{|P|}. The PV design system maximizes Equation (12):

Σ_{sεS}Σᵢ₌₁^{k}|Tᵢ|eₛₜ_{ᵢ} (12),

where s is an integer representing a particular type of PV string, i is a time point, Tᵢ is a time interval partition, and tᵢ is a time point.

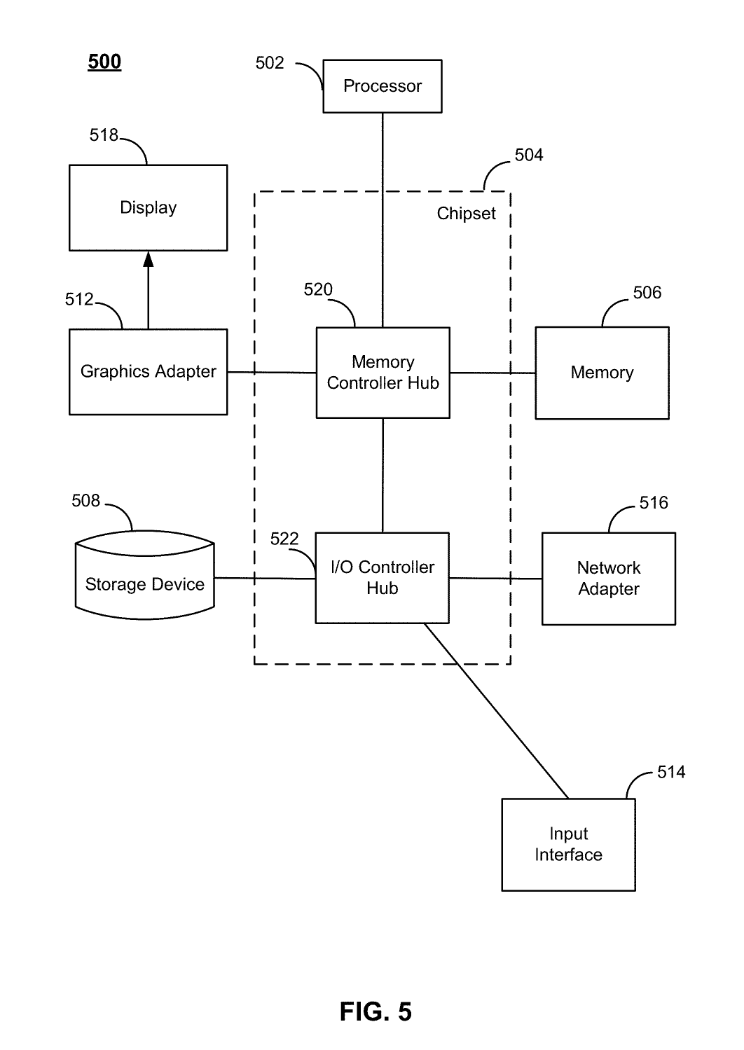

Turning now to a discussion of the implementation the PV design system 130, FIG. 5 is a high-level block diagram illustrating an example computer 500 for implementing the entities shown in FIG. 1. The computer 500 includes at least one processor 502 coupled to a chipset 504. The chipset 504 includes a memory controller hub 520 and an input/output (I/O) controller hub 522. A memory 506 and a graphics adapter 512 are coupled to the memory controller hub 520, and a display 518 is coupled to the graphics adapter 512. A storage device 508, an input device 514, and network adapter 516 are coupled to the I/O controller hub 522. Other embodiments of the computer 500 have different architectures.

The storage device 508 is a non-transitory computer-readable storage medium such as a hard drive, compact disk read-only memory (CD-ROM), DVD, or a solid-state memory device. The memory 506 holds instructions and data used by the processor 502. The input interface 514 is a touch-screen interface, a mouse, track ball, or other type of pointing device, a keyboard, or some combination thereof, and is used to input data into the computer 500. In some embodiments, the computer 500 may be configured to receive input (e.g., commands) from the input interface 514 via gestures from the user. The graphics adapter 512 displays images and other information on the display 518. The network adapter 516 couples the computer 500 to one or more computer networks.

The computer 500 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 508, loaded into the memory 506, and executed by the processor 502.

The types of computers 500 used by the entities of FIG. 1 can vary depending upon the embodiment and the processing power required by the entity. For example, the PV design system 130 can run in a single computer 500 or multiple computers 500 communicating with each other through a network such as in a server farm. The computers 500 can lack some of the components described above, such as graphics adapters 512, and displays 518.

Some portions of the above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

The above description is included to illustrate the operation of certain embodiments and is not meant to limit the scope of the invention. The scope of the invention is to be limited only by the following claims. From the above discussion, many variations will be apparent to one skilled in the relevant art that would yet be encompassed by the spirit and scope of the invention.

What is claimed is:

1. A computer-implemented method of designing photovoltaic (PV) installation comprising:
receiving a desired energy output for a roof having a plurality of roof faces;
receiving a set of candidate PV panel types;
determining one or more possible installation plans comprising:
determining one or more possible combinations of PV panels and power optimization modules, the PV panels having one or more PV panel types that are selected from the set of candidate PV panel types;
determining one or more possible wiring configurations connecting the PV panels and the power optimization modules for each possible combination;
selecting a set of installation plans from the one or more possible installation plans; and
providing the selected set of installation plans to a user device for presentation to a user.

2. The computer-implemented method of claim 1, wherein determining one or more possible combination of PV panels and power optimization modules comprising optimizing a total cost of the PV panels and power optimization modules.

3. The computer-implemented method of claim 2, wherein optimizing the total cost of the PV panels and power optimization modules comprises determining a quantity of the PV panels and a quantity of power optimization modules to minimize the total cost.

4. The computer-implemented method of claim 2, wherein optimizing the total cost of the PV panels and power optimization modules comprises satisfying a plurality of constraints.

5. The computer-implemented method of claim 4, wherein satisfying the plurality of constraints comprises determining one or more PV strings having a first total output energy that is at least the desired energy output, a PV string including one or more PV panels connected in series.

6. The computer-implemented method of claim 5, wherein determining the one or more PV strings further comprises determining an assignment of the PV panels to the one or more PV strings such that the PV panels having a second total output energy that is at least the first total output energy.

7. The computer-implemented method of claim 6, wherein determining the assignment of the PV panels to the one or more PV strings further comprises:
for each PV panel: determining an assignment of the PV panel to one of the roof faces.

8. The computer-implemented method of claim 7, wherein determining the assignment of the PV panels to the one or more PV strings further comprises: for a set of PV panels positioned on a roof face, determining a first time interval when the set of PV panels receives an irradiance level greater than a threshold irradiance level and a second time interval when the set of PV panels receives an irradiance level at most the threshold irradiance level.

9. The computer-implemented method of claim 8, wherein determining the assignment of the PV panels to the one or more PV strings further comprises: grouping the set of PV panels and assigning the set of PV panels to one of the one or more PV strings.

10. The computer-implemented method of claim 9, further comprises applying a time-series clustering to divide a predetermined time interval into time partition to group the set of PV panels.

11. The computer-implemented method of claim 5, further comprises determining an assignment of the one or more PV strings to the roof faces.

12. The computer-implemented method of claim 4, wherein satisfying the plurality of constraints comprises determining an assignment of the PV panels to the roof faces, the PV panels having a total output energy that is at least the desired energy output.

13. The computer-implemented method of claim 4, wherein satisfying the plurality of constraints comprises determining an assignment of the PV panels to the power optimization modules.

14. The computer-implemented method of claim 13, wherein the PV panels are assigned to the power optimization modules such that a power optimization module operates within an operation condition based at least on the PV optimization data.

15. The computer-implemented method of claim 1, wherein determining one or more possible wiring configurations comprising minimizing a total length of wire segments connecting the PV panels and power optimization modules.

16. The computer-implemented method of claim 1, further comprising:
determining one or more candidate PV optimization module types, wherein the power optimization modules have one or more PV optimization types that are selected from the one or more candidate PV optimization module types.

17. The computer-implemented method of claim 1, wherein determining one or more possible installation plans further comprises:
for each possible installation plan:
determining an estimate energy production;
determining a difference between the estimate energy production and the desired energy output; and
responsive to determining the difference greater than a threshold difference, refining the possible installation plan by adjusting at least one of the one or more possible combinations of PV panels and power optimization modules and the one or more possible wiring configurations connecting the PV panels and power optimization modules.

18. The computer-implemented method of claim 1, wherein determining one or more possible installation plans further comprises:
for each possible installation plan:
determining an estimate energy production;
responsive to determining that the estimate energy production is at least the desired energy output, adjusting an upper limit of the estimate energy production to the desired energy output.

19. The computer-implemented method of claim 1, wherein determining one or more possible installation plans further comprises:
for each possible installation plan:
determining an estimate energy production;
responsive to determining that the estimate energy production is less than a lower limit of the estimate energy production, adjusting the lower limit of the estimate energy production to the desired energy output.

20. The computer-implemented method of claim 1, wherein determining one or more possible installation plans further comprises:
for each possible wiring configuration:
identifying an island PV panel;
responsive to identifying the island PV panel, removing the identified island PV panel by repositioning the identified island PV panel to another PV panel.

21. A system of designing photovoltaic (PV) installation comprising:
a processor; and
a non-transitory memory storing instructions thereon, when executed by the processor, cause the processor to perform:
receiving a desired energy output for a roof having a plurality of roof faces;
receiving a set of candidate PV panel types;
determining one or more possible installation plans comprising:
determining one or more possible combinations of PV panels and power optimization modules, the PV panels having one or more PV panel types that are selected from the set of candidate PV panel types;
determining one or more possible wiring configurations connecting the PV panels and the power optimization modules for each possible combination;
selecting a set of installation plans from the one or more possible installation plans; and
providing the selected set of installation plans to a user device for presentation to a user.
